(19) United States
(12) Patent Application Publication
(10) Pub. No.: US 2012/0204686 A1
(43) Pub. Date: Aug. 16, 2012

(54) Wrench Extender With Torque Device

(76) Inventor: Jason William Carlson, Eagan, MN (US)

(21) Appl. No.: 13/025,397

(22) Filed: Feb. 11, 2011

(51) Int. Cl. B25B 23/144; B25B 23/142

(52) U.S. Cl. 81/479; 81/478

(57) ABSTRACT

A wrench extender with a torque device comprises an elongated body to attach to a wrench; a handle at an end of the elongated body; a torque device mounted above where the elongated body and the handle meet, where the torque device indicates an amount of torque exerted by the wrench extender during use; a set of connection hooks fastened to the elongated body, where the set of connection hooks include a first connection hook and a second connection hook; the first connection hook is fastened at an opposite end of the elongated body from the handle, and the second connection hook is fastened to the elongated body between the first connection hook and the handle, wherein the set of connection hooks secure the wrench to the elongated body, and wherein the elongated body adds length to the wrench to allow the wrench to be used in confined spaces.

### BACKGROUND OF THE INVENTION

1. Field of the Invention

The present invention relates to a wrench extender to assist when using a wrench in confined spaces wherein the wrench extender further includes a torque device to allow a user to monitor how much torque they are applying while using the wrench extender.

2. Description of Related Art

A wrench is a common tool used to tighten bolts and nuts. Typically a person repeatedly twists and adjusts the wrench around a bolt head to securely tighten the bolt in place. The repetitive action of twisting often becomes tiring and sometimes painful to the person. In other circumstances the person has difficulty using the wrench because the space where the bolt is located is obstructed or through a narrow passage. The person may hurt their hand or fingers trying to use the wrench in the confined space, or ultimately they may be unable to use the wrench at all.

Accessories and modifications have been developed to function with standard wrenches. First, wrench extenders were designed to confront the problem of tightening bolts in confined spaced normally too small to use standard wrenches. The wrench extenders lengthen the shaft of the wrench to enable the user to reach the bolt. For example, U.S. Pat. No. 4,644,600 by Jimmy D. Fugate discloses an extension handle for wrenches wherein a flat elongated bar includes a pair of stirrups to engage the wrench. The additional length from the elongated bar allows the user to turn the wrench in the tight space.

Another type of wrench modification is a torque wrench. The torque wrenches are used to apply a specific amount of torque to a fastener. An internal mechanism within the torque wrench allows the user to set how much torque they wish to exert, and then the torque wrench notifies the user when that amount has been reached. This is especially useful when working with screws and bolts where the tightness is crucial. Commonly, the torque wrenches have a single attached head and are available at a fixed length. A wrench extender cannot be used with the torque wrench because of the internal torque mechanism. Therefore, if the torque wrench cannot reach a fastener a standard wrench will have to be substituted.

It would be desirable in the art to provide a wrench extender that combines the ability of using a wrench in a confined space with the ability to predetermine the amount of force applied.

It would also be beneficial in the art to provide a wrench extender with a display to indicate to the user how much torque is being exerted.

### SUMMARY OF THE INVENTION

In view of the foregoing disadvantages inherent in the prior art, the purpose of the present disclosure is to provide a wrench extender to assist when using a wrench in confined spaces wherein the wrench extender further includes a torque device to allow a user to monitor how much torque they are applying while using the wrench extender.

An object of the present invention is to combine a wrench extender with a torque wrench wherein a user may predetermine how much torque to apply while using the wrench extender.

Another object of the present invention is to provide a display wherein the display indicates to the user how much torque they are exerting during use of the wrench extender.

To achieve the above objects, in an aspect of the present invention, a wrench extender with a torque device comprises an elongated body to attach to a wrench; a handle at an end of the elongated body; a torque device mounted above where the elongated body and the handle meet, where the torque device indicates an amount of torque exerted by the wrench extender during use; a set of connection hooks fastened to the elongated body, where the set of connection hooks include a first connection hook and a second connection hook; the first connection hook is fastened at an opposite end of the elongated body from the handle, and the second connection hook is fastened to the elongated body between the first connection hook and the handle, wherein the set of connection hooks secure the wrench to the elongated body, and wherein the elongated body adds length to the wrench to allow the wrench to be used in confined spaces.

These together with other aspects of the present invention, along with the various features of novelty that characterize the present invention, are pointed out with particularity in the claims annexed hereto and form a part of this present invention. For a better understanding of the present invention, its operating advantages, and the specific objects attained by its uses, reference should be made to the accompanying drawings and descriptive matter in which there are illustrated exemplary embodiments of the present invention.

### BRIEF DESCRIPTION OF THE DRAWINGS

The advantages and features of the present invention will become better understood with reference to the following detailed description and claims taken in conjunction with the accompanying drawings, wherein like elements are identified with like symbols, and in which:

FIG. 1 depicts a perspective view of a wrench extender in accordance with an exemplary embodiment of the present invention; and

FIG. 2 depicts a side view of a wrench extender in accordance with an exemplary embodiment of the present invention.

Like reference numerals refer to like parts throughout the description of several views of the drawings.

### DETAILED DESCRIPTION OF THE DRAWINGS

The present invention relates to a wrench extender to assist when using a wrench in confined spaces wherein the wrench extender further includes a torque device to allow a user to monitor how much torque they are applying while using the wrench extender. The wrench extender with torque device is an adapter to more comfortably use the wrench while simultaneously applying a specified amount of torque. The wrench fastens to the elongated body of the wrench extender with a set of connection hooks. Furthermore the wrench extender includes a torque device to measure and predetermine how much torque is used by the wrench extender. By combining the wrench extender with the torque device, wrenches with different heads may be used and torque measurements in confined spaces may be taken. Therefore, projects utilizing the wrench extender with torque device are easier to perform while allowing the user to complete the work in a more time efficient and less damaging manner.

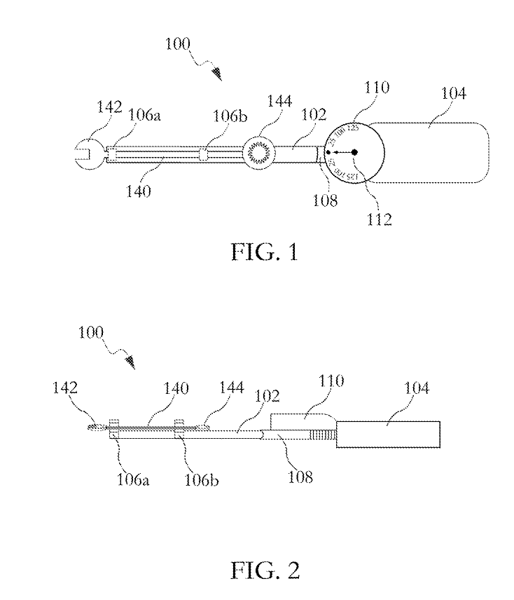

Tuning now descriptively to the drawings, referring to FIG. 1, a perspective view of a wrench extender (100) is shown in accordance with an exemplary embodiment of the present invention. The wrench extender (100) includes an elongated body (102) which may be an extension bar or rod. The elongated body (102) is made of a hardened steel material to provide the durability and strength required for tool working The elongated body (102) provides additional length and leverage to a wrench (140) when the wrench (140) is secured against the elongated body (102). This may be especially useful in small hard to reach areas where a user has difficulty fitting their hand or fingers while grasping the wrench (140).

Attached to an end of the elongated body (102) is a handle (104). The handle (104) provides a gripping portion for the user to grasp the wrench extender (100) during use. The handle (104) may comprise an internal metal bar surrounded with a rubberized grip pad. The internal metal bar ensures strength for the handle (104) while the rubberized grip pad provides a comfortable surface against the user's hand.

Connected to the elongated body (102), at an opposite end to where the handle (104) is attached, are a set of connection hooks (106a, 106b) (hereinafter connection hooks). The connection hooks (106a, 106b) are assembled wherein a first connection hook (106a) is fastened to the end of the elongated body (102) and a second connection hook (106b) is fastened towards a middle portion of the elongated body (102). The connection hooks (106a, 106b) are attached to the elongated body (102) by fastening one side of the connection hook (106a, 106b) to the elongated body (102) and the connection hook (106a, 106b) hovers above the elongated body (102) while enabling the opposite side to remain detached or open. The open side of the connection hook (106a, 106b) accepts the wrench (140) and enables it to slide between the elongated body and the connection hooks (106a, 106b). The wrench (140) is able to easily fasten into and out of the connection hooks (106a, 106b) allowing the user to quickly transition between using an open end (142) and a closed end (144).

During use, the wrench (140) presses against the connection hooks (106a, 106b) to radially engage itself within the wrench extender (100). The wrench (140) remains engaged within the connection hooks (106a, 106b) because the first connection hook (106a) is attached on a left side of the elongated body (102) whereas the second connection hook (106b) is attached on a right side of the elongated body (102). As the user twists the wrench extender (100) with attached wrench (140) in a clockwise direction, the first connection hook (106a) opposes the movement while the second connection hook (106b) facilitates the movement.

Accordingly, mounted above where the handle (104) meets the elongated body (102) is a torque device (110). The torque device (110) indicates an amount of torque applied to the tool during use. As is commonly known in the art, the torque device (110) is used by setting the desired amount of torque to be exerted by the wrench extender (100). When the desired amount of torque is reached a breakpoint (108) will click, emitting an audible and a tactile sensation, indicating to the user that the desired amount of torque has been reached and that they must discontinue turning. The breakpoint (108) is positioned on the elongated body (102), below where the torque device (110) is attached. The breakpoint (108) may either click or completely bend when the desired torque is reached. By bending, the breakpoint (108) prevents further turning of the wrench extender (100) therefore hindering the user from applying too much torque.

The torque device (110) may be equipped with a deflecting beam display (112) or a digital display (not shown). The deflecting beam display (112) utilizes a rotational rod to identify the amount of torque exerted. As greater amounts of torque are applied the rotational rod moves to indicate the corresponding measurement number. The same principle is applied to the digital display but rather than mechanical parts the digital display comprises electronic parts for a direct readout on a display screen.

Referring now to FIG. 2, a side view of the wrench extender (100) is shown in accordance with an exemplary embodiment of the present invention. FIG. 2 better illustrates how the connection hooks (106a, 106b) are fastened to the elongated body (102) and how they are elevated to accept the wrench (140). The wrench extender (100) fits easily into tight places or areas too far out of the user's reach where the user may need to tighten a nut or bolt. As such, the additional leverage and torque imparted by the wrench extender (100) makes using the wrench (140) easier with less effort and fatigue.

The foregoing descriptions of specific embodiments of the present invention have been presented for purposes of illustration and description. They are not intended to be exhaustive or to limit the invention to the precise forms disclosed, and obviously many modifications and variations are possible in light of the above teaching. The exemplary embodiment was chosen and described in order to best explain the principles of the invention and its practical application, to thereby enable others skilled in the art to best utilize the invention and various embodiments with various modifications as are suited to the particular use contemplated.

What is claimed is:

1. A wrench extender with a torque device comprises:
an elongated body, where said elongated body attaches to a wrench;
a handle at an end of said elongated body, where said handle turns and controls said elongated body;
a torque device mounted above where said elongated body and said handle meet, where said torque device indicates an amount of torque exerted by said wrench extender during use;
a set of connection hooks fastened to said elongated body, where said set of connection hooks include a first connection hook and a second connection hook;
said first connection hook is fastened at an opposite end of said elongated body from said handle, and
said second connection hook is fastened to said elongated body between said first connection hook and said handle, where said set of connection hooks secure said wrench to said elongated body, and
wherein said elongated body adds length to said wrench to allow said wrench to be used in confined spaces.

2. The wrench extender with a torque device according to claim 1, wherein said first connection hook fastens to a left side of said elongated body and said second connection hook fastens to a right side of said elongated body to radially secure said wrench to said elongate body.

3. The wrench extender with a torque device according to claim 1, wherein said torque device enables a user to set a desired amount of torque to be applied by said wrench extender.

4. The wrench extender with a torque device according to claim 3, wherein said torque device includes a breakpoint where said breakpoint clicks when said desired amount of torque is applied.

5. The wrench extender with a torque device according to claim 1, wherein said handle includes a rubberized grip pad.

6. The wrench extender with a torque device according to claim 1, wherein said torque device includes a deflecting beam display.

7. The wrench extender with a torque device according to claim 1, wherein said torque device includes a digital display.
